(19) United States
(12) Patent Application Publication
(10) Pub. No.: US 2014/0135014 A1
(43) Pub. Date: May 15, 2014

(54) Cell Handover Control Method, Related Device, and Communications System

(71) Applicant: Huawei Technologies Co., Ltd., Shenzhen (CN)

(72) Inventor: Shangfeng Li, Beijing (CN)

(73) Assignee: Huawei Technologies Co., Ltd., Shenzhen (CN)

(21) Appl. No.: 14/159,672

(22) Filed: Jan. 21, 2014

Related U.S. Application Data
(63) Continuation of application No. PCT/CN2012/084060, filed on Nov. 5, 2012.

(30) Foreign Application Priority Data
Nov. 18, 2011 (CN) 201110369353.5

(51) Int. Cl. H04W 36/00

(52) U.S. Cl. CPC H04W 36/0072
USPC 455/436

(57) ABSTRACT

A cell handover control method, a related device, and a communications system can shorten channel establishment time during Long Term Evolution (LTE) cell handover, and improve real-time monitoring effect after a user equipment (UE) is handed over to a target cell. The method of embodiments of the present invention includes: receiving, by a UE, a handover configuration message sent by a source base station, where the handover configuration message includes paging control channel (PCCH) configuration information and broadcast control channel (BCCH) configuration information of a target cell; and establishing, by the UE, a PCCH channel according to the PCCH configuration information to monitor network paging, and determining, according to the BCCH configuration information, a moment for updating a system message after reception of the paging.

### CROSS-REFERENCE TO RELATED APPLICATIONS

This application is a continuation of International Application No. PCT/CN2012/084060, filed on Nov. 5, 2012, which claims priority to Chinese Patent Application No. 201110369353.5, filed on Nov. 18, 2011, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the communications field, and in particular, to a cell handover control method, a related device, and a communications system.

### BACKGROUND

With the development of the radio network technology, a popularizing rate of radio terminals is continuously growing, and a user equipment (UE) is a typical type of radio terminal.

An important feature of the UE is good portability. When using the UE, a user often moves to different places. However, a coverage of a base station that serves the UE is limited, so the UE is usually handed over among different base stations.

In an existing long term evolution (LTE) network, when moving from a source cell to a target cell, the UE needs to initiate a process of LTE cell handover, where the source cell refers to a cell served by the source base station, and the target cell refers to a cell served by a target base station.

First, the UE may receive a handover configuration message RRC CONN RECFG sent by the source base station, and the UE sends a handover configuration completion message RRC CONN RECFG CMPLETE to the target base station. Then, the UE may receive a system message broadcast by the target base station, read paging control channel (PCCH) configuration information and broadcast control channel (BCCH) configuration information of the target cell from a system information block 2 (SIB2) broadcast by the target base station, establish a PCCH channel according to the PCCH configuration information to monitor network paging, and determine, according to the BCCH configuration information, a moment for updating the system message after reception of the paging.

However, it can be seen from the above process of LTE cell handover that, after sending the handover configuration completion message to the target base station, the UE has to receive the SIB2 to obtain the PCCH configuration information and the BCCH configuration information of the target cell to monitor the network, thereby increasing time required for channel establishment, and affecting real-time monitoring effect after the UE is handed over to the target cell.

### SUMMARY

Embodiments of the present invention provide a cell handover control method, a related device, and a communications system, which can shorten channel establishment time during LTE cell handover, and improve real-time monitoring effect after a UE is handed over to a target cell.

A cell handover control method provided in an embodiment of the present invention includes: receiving, by a UE, a handover configuration message sent by a source base station, where the handover configuration message includes PCCH configuration information and BCCH configuration information of a target cell; and establishing, by the UE, a PCCH channel according to the PCCH configuration information to monitor network paging, and determining, according to the BCCH configuration information, a moment for updating a system message after reception of the paging.

Optionally, before or after the establishing, by the UE, a PCCH channel according to the PCCH configuration information to monitor network paging, and determining, according to the BCCH configuration information, a moment for updating a system message after reception of the paging, the method further includes sending, by the UE, a handover configuration completion message to a target base station.

Optionally, when the moment for updating the system message is reached, the UE establishes a BCCH channel; the UE receives, via the BCCH channel, a system message broadcast by the target base station; and the UE releases the BCCH channel.

A cell handover control method provided in an embodiment of the present invention includes: receiving, by a source base station, a measurement report sent by a UE; determining, by the source base station, a target base station corresponding to the measurement report; obtaining, by the source base station, PCCH configuration information and BCCH configuration information of a target cell from the target base station; and sending, by the source base station, a handover configuration message to the UE, where the handover configuration message includes the PCCH configuration information and the BCCH configuration information.

Optionally, the obtaining, by the source base station, PCCH configuration information and BCCH configuration information of a target cell from the target base station includes: sending, by the source base station, a handover request to the target base station; and receiving, by the source base station, a handover response sent by the target base station, where the handover response includes the PCCH configuration information and the BCCH configuration information of the target cell.

A cell handover control method provided in an embodiment of the present invention includes: receiving, by a target base station, a handover request sent by a source base station; obtaining, by the target base station, PCCH configuration information and BCCH configuration information of a target cell; and sending, by the target base station, a handover response to the source base station, where the handover response includes the PCCH configuration information and the BCCH configuration information of the target cell.

Optionally, after the sending, by the target base station, a handover response to the source base station, the method further includes: receiving, by the target base station, a handover configuration completion message sent by the UE; and broadcasting, by the target base station, a system message on a BCCH channel.

A user equipment provided in an embodiment of the present invention includes: a configuration information receiving unit configured to receive a handover configuration message sent by a source base station, where the handover configuration message includes PCCH configuration information and BCCH configuration information of a target cell; and a channel monitoring processing unit configured to establish a PCCH channel according to the PCCH configuration information received by the configuration information receiving unit to monitor network paging, and determine, according to the BCCH configuration information received by the configuration information receiving unit, a moment for updating a system message after reception of the paging.

Optionally, the user equipment further includes a completion message sending unit configured to send a handover configuration completion message to a target base station.

Optionally, the user equipment further includes: a channel establishing unit configured to establish a BCCH channel when the moment determined by the channel monitoring processing unit for updating the system message is reached; a system message receiving unit configured to receive, via the BCCH channel established by the channel establishing unit, a system message broadcast by the target base station; and a channel releasing unit configured to release the BCCH channel after the system message receiving unit finishes receiving the system message.

A base station provided in an embodiment of the present invention includes: a measurement report receiving unit configured to receive a measurement report sent by a UE; a determining unit configured to determine a target base station corresponding to the measurement report received by the measurement report receiving unit; an obtaining unit configured to obtain PCCH configuration information and BCCH configuration information of a target cell from the target base station determined by the determining unit; and a sending unit configured to send a handover configuration message to the UE, where the handover configuration message includes the PCCH configuration information and the BCCH configuration information that are obtained by the obtaining unit.

Optionally, the obtaining unit includes: a sending module configured to send a handover request to the target base station; and a receiving module configured to receive a handover response sent by the target base station, where the handover response includes the PCCH configuration information and the BCCH configuration information of the target cell.

A base station provided in an embodiment of the present invention includes: a request receiving unit configured to receive a handover request sent by a source base station; an information obtaining unit configured to obtain PCCH configuration information and BCCH configuration information of a target cell; and an information sending unit configured to send a handover response to the source base station, where the handover response includes the PCCH configuration information and the BCCH configuration information of the target cell that are obtained by the information obtaining unit.

Optionally, the base station further includes: a completion message receiving unit configured to receive a handover configuration completion message sent by a UE; and a broadcasting unit configured to broadcast a system message on a BCCH channel.

A communications system provided in an embodiment of the present invention includes: a source base station configured to receive a measurement report sent by a UE, determine a target base station corresponding to the measurement report, obtain PCCH configuration information and BCCH configuration information of a target cell from the target base station, and send a handover configuration message to the UE, where the handover configuration message includes the PCCH configuration information and the BCCH configuration information; the UE configured to send the measurement report to the source base station, receive the handover configuration message sent by the source base station, where the handover configuration message includes the PCCH configuration information and the BCCH configuration information of the target cell, establish a PCCH channel according to the PCCH configuration information to monitor network paging, determine, according to the BCCH configuration information, a moment for updating a system message after reception of the paging, and send a handover configuration completion message to the target base station; and the target base station configured to receive the handover configuration completion message sent by the user equipment, and broadcast the system message on a BCCH channel.

It can be seen from the above technical solution that, the embodiments of the present invention has the following advantages.

In the embodiments of the present invention, the handover configuration message received by the UE from the source base station includes the PCCH configuration information and the BCCH configuration information of the target cell, and the UE may directly establish the PCCH channel according to the PCCH configuration information to monitor the network paging, and determine, according to the BCCH configuration information, the moment for updating the system message after reception of the paging. Since the handover configuration message is sent before an SIB2 broadcast by the target base station, the UE may receive the PCCH configuration information and the BCCH configuration information in a more timely manner, so as to shorten channel establishment time during LTE cell handover, thereby improving real-time monitoring effect after the UE is handed over to the target cell.

### BRIEF DESCRIPTION OF THE DRAWINGS

FIG. 1 is a schematic diagram of a cell handover control method according to an embodiment of the present invention;

FIG. 2 is a schematic diagram of a cell handover control method according to another embodiment of the present invention;

FIG. 3 is a schematic diagram of a cell handover control method according to another embodiment of the present invention;

FIG. 4 is a schematic diagram of a cell handover control method according to another embodiment of the present invention;

FIG. 5 is a schematic diagram of a UE according to an embodiment of the present invention;

FIG. 6 is a schematic diagram of a UE according to another embodiment of the present invention;

FIG. 7 is a schematic diagram of a base station according to an embodiment of the present invention;

FIG. 8 is a schematic diagram of a base station according to another embodiment of the present invention; and

FIG. 9 is a schematic diagram of a communications system according to an embodiment of the present invention.

### DETAILED DESCRIPTION

Embodiments of the present invention provide a cell handover control method, a related device, and a communications system, which can shorten channel establishment time during LTE cell handover, and improve real-time monitoring effect after a UE is handed over to a target cell.

All aspects of the embodiments of the present invention are described in combination with a UE and/or a base station.

The UE may be a radio terminal or a wired terminal. The radio terminal may refer to a device that provides a user with voice and/or data connectivity, a handheld device with a wireless connection function, or another processing device connected to a wireless modem. The radio terminal may communicate with one or more core networks through a radio access network (RAN). The radio terminal may be a mobile terminal, such as a mobile phone (or referred to as “cellular” phone) and a computer with a mobile terminal, for example, may be a portable, pocket, handheld, built-in-computer, or vehicle-mounted mobile apparatus, which exchanges languages and/or data with the RAN. For example, the radio terminal may be a personal communication service (PCS) phone, a cordless phone, a Session Initiation Protocol (SIP) telephone set, a wireless local loop (WLL) station, a personal digital assistant (PDA), or another device. The radio terminal may also be referred to as a system, a subscriber unit, a subscriber station, a mobile station, a mobile, a remote station, an access point, a remote terminal, an access terminal, a user terminal, a user agent, a user device, or a UE.

The base station (for example, an access point) may refer to a device that communicates with the radio terminal on an air interface via one or more sectors in an access network. The base station may be configured to convert a received air frame to an Internet Protocol (IP) packet or vice versa, and act as a router between the radio terminal and other parts of the access network, where the other parts of the access network may include an IP network. The base station may further coordinate attribute management for the air interface. For example, the base station may be an evolutional base station (NodeB, eNB, e-NodeB, or evolutional Node B) in an LTE, and is not limited in the embodiments.

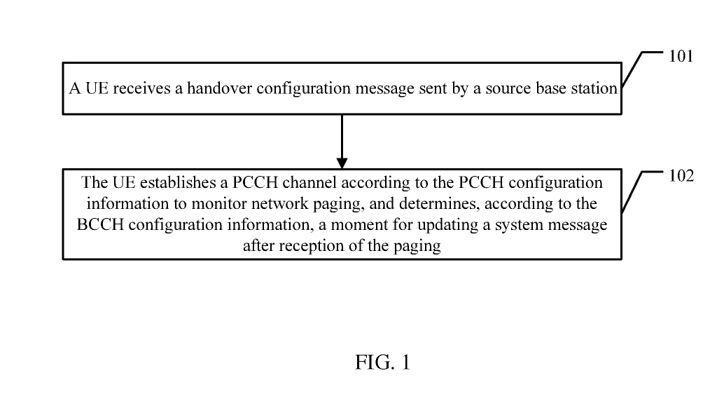

Specific descriptions are made below. Referring to FIG. 1, a cell handover control method according to an embodiment of the present invention includes the following steps.

101: A UE receives a handover configuration message sent by a source base station.

In this embodiment, when the UE determines to initiate cell handover, or a network side determines to require the UE to initiate cell handover, the UE may send a measurement report to the source base station, and may receive the handover configuration message from the source base station.

The handover configuration cell includes PCCH configuration information and BCCH configuration information of a target cell.

It should be noted that, the reason for the UE to initiate cell handover may be location update, routing area update, or signal quality reduction, and the details are not limited herein.

102: The UE establishes a PCCH channel according to the PCCH configuration information to monitor network paging, and determines, according to the BCCH configuration information, a moment for updating a system message after reception of the paging.

After receiving the handover configuration message from the source base station, the UE may read the PCCH configuration information and the BCCH configuration information of the target cell from the message, establish the PCCH channel according to the PCCH configuration information to monitor network paging, and determine, according to the BCCH configuration information, the moment for updating the system message after reception of the paging.

The PCCH configuration information in this embodiment is used to establish the PCCH channel, and the PCCH channel is used to monitor the network paging. The BCCH configuration information in this embodiment is used to determine the moment for updating the system message after the network paging is monitored.

Up to this point, the UE may monitor the network paging in the target cell, which may be regarded as completion of the cell handover.

In this embodiment, the handover configuration message received by the UE from the source base station includes the PCCH configuration information and the BCCH configuration information of the target cell, and the UE may directly establish the PCCH channel according to the PCCH configuration information to monitor the network paging, and determine, according to the BCCH configuration information, the moment for updating the system message after reception of the paging. Since the handover configuration message is sent before an SIB2 broadcast by a target base station, the UE may receive the PCCH configuration information and the BCCH configuration information in a more timely manner, so as to shorten channel establishment time during LTE cell handover, thereby improving real-time monitoring effect after the UE is handed over to the target cell.

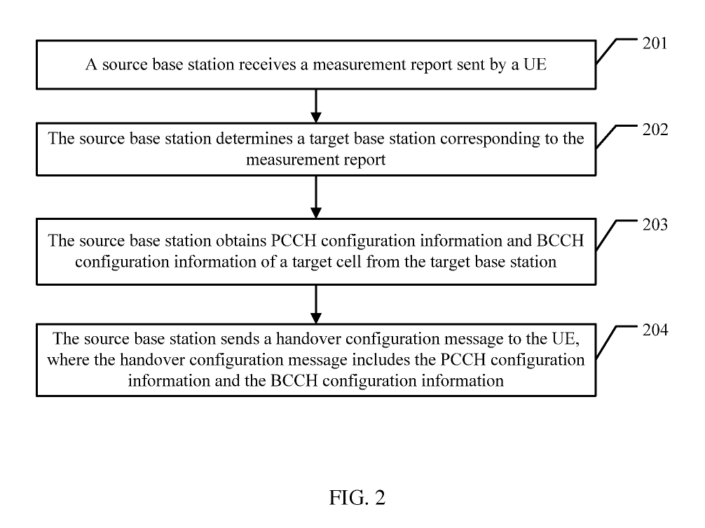

In the above embodiment, the cell handover control method of the present invention is described from the perspective of the user equipment, and the handover control method of the present invention will be described hereinafter from the perspective of the source base station. Referring to FIG. 2, the cell handover control method according to another embodiment of the present invention includes the following steps.

201: A source base station receives a measurement report sent by a UE.

In this embodiment, when the UE determines to initiate cell handover, or a network side determines to require the UE to initiate cell handover, the UE may send the measurement report to the source base station.

The handover configuration cell includes PCCH configuration information and BCCH configuration information of a target cell.

It should be noted that, the reason for the UE to initiate cell handover may be location update, routing area update, or signal quality reduction, and the details are not limited herein.

202: The source base station determines a target base station corresponding to the measurement report.

After receiving the measurement report sent by the UE, the source base station may determine the target base station corresponding to the measurement report.

It should be noted that, the measurement report sent by the UE may carry information of several candidate target base stations for the source base station to select from, or the source base station may also select the target base station according to other information, and the specific process is commonly known to persons skilled in the art, and is not limited herein.

203: The source base station obtains the PCCH configuration information and the BCCH configuration information of the target cell from the target base station.

After determining the target base station, the source base station may obtain the PCCH configuration information and the BCCH configuration information of the target cell from the target base station, and the specific obtaining process is as follows: the source base station sends a handover request to the target base station; and the source base station receives a handover response sent by the target base station, where the handover response includes the PCCH configuration information and the BCCH configuration information of the target cell.

Or, the source base station may also obtain the PCCH configuration information and the BCCH configuration information of the target cell from the target base station through another process of interaction with the target base station, which is not limited herein.

204: The source base station sends a handover configuration message to the UE.

In this embodiment, after obtaining the PCCH configuration information and the BCCH configuration information of the target cell from the target base station, the source base station may send the handover configuration message to the UE, where the handover configuration message includes the PCCH configuration information and the BCCH configuration information of the target cell.

In this embodiment, the source base station may send the handover configuration message including the PCCH configuration information and the BCCH configuration information of the target cell to the UE, so that after receiving the message, the UE may directly establish a PCCH channel according to the PCCH configuration information to monitor the network paging, and determine, according to the BCCH configuration information, a moment for updating a system message after reception of the paging. Since the handover configuration message is sent before an SIB2 broadcast by the target base station, the UE may receive the PCCH configuration information and the BCCH configuration information in a more timely manner, so as to shorten channel establishment time during LTE cell handover, thereby improving real-time monitoring effect after the UE is handed over to the target cell.

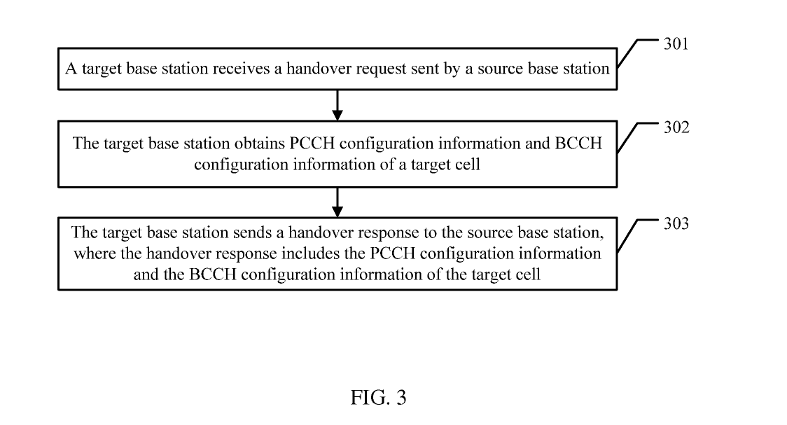

In the above embodiments, the cell handover control method of the present invention is described from the perspectives of the UE and the source base station, and the handover control method of the present invention will be described hereinafter from the perspective of the target base station. Referring to FIG. 3, the cell handover control method according to another embodiment of the present invention includes the following steps.

301: A target base station receives a handover request sent by a source base station.

In this embodiment, when a UE determines to initiate cell handover, or a network side determines to require the UE to initiate cell handover, the UE may send a measurement report to the source base station.

The source base station may determine the target base station according to the measurement report, and send the handover request to the target base station, so the target base station may receive the handover request sent by the source base station.

302: The target base station obtains PCCH configuration information and BCCH configuration information of a target cell.

After receiving the handover request sent by the source base station, the target base station may obtain the PCCH configuration information and the BCCH configuration information of the target cell.

It should be noted that, the target base station may obtain the PCCH configuration information and the BCCH configuration information of the cell that the target base station serves (that is, the target cell) from the target base station, and may also obtain the PCCH configuration information and the BCCH configuration information of the target cell from another network element (for example, a network element of a core network), and the details are not limited herein.

303: The target base station sends a handover response to the source base station.

In this embodiment, the target base station may carry the PCCH configuration information and the BCCH configuration information of the target cell obtained in step 302 in the handover response and send the handover response to the source base station.

In this embodiment, the target base station may carry the obtained PCCH configuration information and BCCH configuration information of the target cell in the handover response and send the handover response to the source base station, so that the source base station may send a handover configuration message including the PCCH configuration information and the BCCH configuration information of the target cell to the UE, and further, after receiving the message, the UE may directly establish a PCCH channel according to the PCCH configuration information to monitor the network paging, and determine, according to the BCCH configuration information, a moment for updating a system message after reception of the paging. Since the handover configuration message is sent before an SIB2 broadcast by the target base station, the UE may receive the PCCH configuration information and the BCCH configuration information in a more timely manner, so as to shorten channel establishment time during LTE cell handover, thereby improving real-time monitoring effect after the UE is handed over to the target cell.

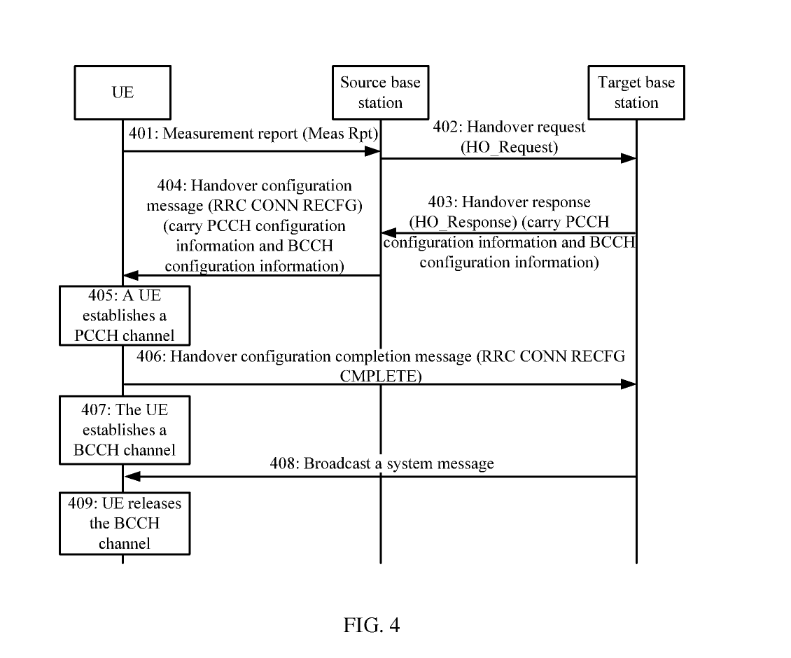

In the above embodiments, the cell handover control method of the present invention is described respectively from the perspectives of the UE, the source base station, and the target base station. In order to facilitate understanding, the cell handover control method of the present invention will be described below in detail with a specific example of an interaction process. Referring to FIG. 4, the cell handover control method according to another embodiment of the present invention includes the following steps.

401: A UE sends a measurement report (Meas Rpt) to a source base station.

When the UE detects that a signal quality of a current serving cell (that is, a source cell) is lower than a preset threshold, and/or that there are candidate target cells with signal qualities higher than the preset threshold, the UE may send the measurement report to the source base station, where the measurement report carries information of several candidate target base stations.

402: The source base station sends a handover request (HO_Request) to a target base station.

In this embodiment, after receiving the measurement report sent by the UE, the source base station may determine the target base station corresponding to the measurement report.

It should be noted that, the measurement report sent by the UE may carry information of several candidate target base stations for the source base station to select from, or the source base station may also select the target base station according to other information, and the specific process is commonly known to persons skilled in the art, and is not limited herein.

After determining the target base station, the source base station may send the handover request to the target base station, to notify the target base station of preparing for cell handover.

403: The target base station sends a handover response (HO_Response) to the source base station.

When receiving the handover request sent by the source base station, the target base station may obtain PCCH configuration information and BCCH configuration information of the target cell.

It should be noted that, the target base station may obtain the PCCH configuration information and the BCCH configuration information of the cell that the target base station serves (that is, the target cell) from the target base station, and may also obtain the PCCH configuration information and the BCCH configuration information of the target cell from another network element (for example, a network element of a core network), and the details are not limited herein.

Subsequently, the target base station may carry the obtained PCCH configuration information and BCCH configuration information of the target cell in the handover response and send the handover response to the source base station.

404: The source base station sends a handover configuration message to the UE.

After receiving the handover response which is sent by the target base station and includes the PCCH configuration information and the BCCH configuration information of the target cell, the source base station may carry the PCCH configuration information and the BCCH configuration information of the target cell in the handover configuration message and send the handover configuration message to the UE. A specific structure of the handover configuration message may be as follows;

RadioResourceConfigCommonSIB ::= SEQUENCE {

| | |
|---|---|
| rach-ConfigCommon | RACH-ConfigCommon, |
| bcch-Config | BCCH-Config, |

pcch-Config

| PCCH-Config, | |
|---|---|
| ... | |
| } | |
| RadioResourceConfigCommon ::= | SEQUENCE { |

| | |
|---|---|
| pcch-Config | PCCH-Config, OPTIONAL, -- Need ON |
| bcch-Config | BCCH-Config, OPTIONAL, -- Need ON |

| ... | |
|---|---|
| } | |
| BCCH-Config ::= | SEQUENCE { |

| | |
|---|---|
| modificationPeriodCoeff | ENUMERATED {n2, n4, n8, n16} |

| } | |
|---|---|
| PCCH-Config ::= | SEQUENCE { |

| | |
|---|---|
| defaultPagingCycle | ENUMERATED { |

rf32, rf64, rf128, rf256},

nB

ENUMERATED {

fourT, twoT, oneT, halfT, quarterT, oneEighthT, oneSixteenthT, oneThirtySecondT}
}

Through the above manner, the PCCH configuration information and the BCCH configuration information of the target cell are carried in the handover configuration message. It should be noted that, the above is merely one manner of carrying the PCCH configuration information and the BCCH configuration information of the target cell in the handover configuration message. It is understandable that, in a practical application, more manners may be adopted to carry the PCCH configuration information and the BCCH configuration information of the target cell in the handover configuration message, and the details are not limited herein.

405: The UE establishes a PCCH channel.

After receiving the handover configuration message sent by the source base station, the UE may read the PCCH configuration information and the BCCH configuration information of the target cell from the handover configuration message.

The PCCH configuration information is used to establish the PCCH channel, and the PCCH channel is used to monitor network paging. The BCCH configuration information is used to determine a moment for updating a system message after the network paging is monitored. Therefore, the UE may establish the PCCH channel in the target cell according to the received PCCH configuration information of the target cell, and monitor the network paging, and may further determine the moment for updating the system message after monitoring the network paging.

After the UE establishes the PCCH channel in the target cell, and starts to monitor the network paging, the UE may be considered to complete the cell handover already, and may start to monitor a message such as a commercial mobile alert service (CMAS) and an earthquake and tsunami warning system (ETWS).

406: The UE sends a handover configuration completion message to the target base station.

After the UE establishes the PCCH channel in the target cell, and starts to monitor the network paging, the UE may send the handover configuration completion message to the target base station, so the UE is handed over to the target cell formally.

407: The UE establishes a BCCH channel.

The UE may establish the PCCH channel in the target cell according to the received PCCH configuration information of the target cell, and monitor the network paging. When learning, by monitoring the network paging, that the system message needs to be updated, the UE may establish the BCCH channel in the target cell to receive a system message broadcast by the target base station.

408: The target base station broadcasts a system message on the BCCH channel.

After the UE establishes the BCCH channel in the target cell, the target base station may broadcast the system message on the BCCH channel, where the system message may be a master information block (MIB) message, a system information block 1 (SIB1) message, an SIB2 message, or a system message of another type, and the details are not limited herein.

409: The UE releases the BCCH channel.

After receiving the system message broadcast by the target base station on the BCCH channel established in the target cell, the UE may release the BCCH channel, and update the system message.

In this embodiment, the handover configuration message received by the UE from the source base station includes the PCCH configuration information and the BCCH configuration information of the target cell, and the UE may directly establish the PCCH channel according to the PCCH configuration information to monitor the network paging, and determine, according to the BCCH configuration information, the moment for updating the system message after reception of the paging. Since the handover configuration message is sent before an SIB2 broadcast by the target base station, the UE may receive the PCCH configuration information and the BCCH configuration information in a more timely manner, so as to shorten channel establishment time during LTE cell handover, thereby improving real-time monitoring effect after the UE is handed over to the target cell.

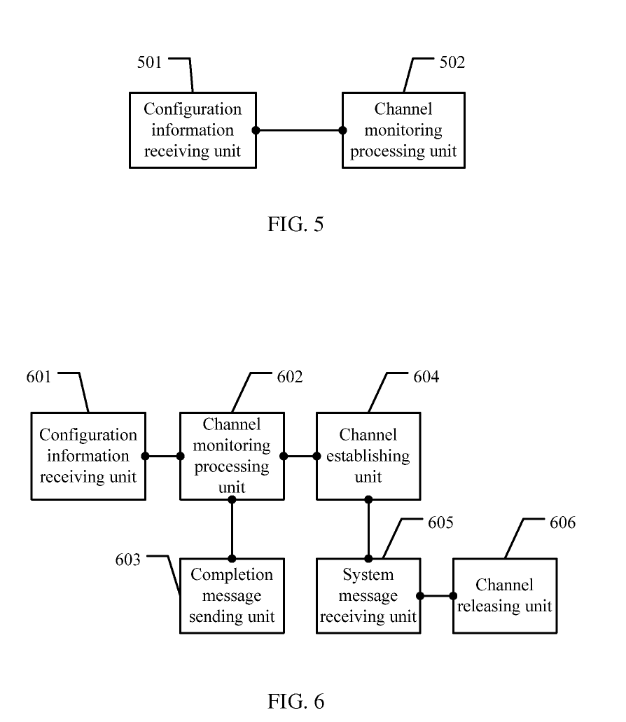

The embodiments of the cell handover control method of the present invention are described above, and a UE according to an embodiment of the present invention will be described hereinafter. Referring to FIG. 5, the UE according to an embodiment of the present invention includes: a configuration information receiving unit 501 configured to receive a handover configuration message sent by a source base station, where the handover configuration message includes PCCH configuration information and BCCH configuration information of a target cell; and a channel monitoring processing unit 502 configured to establish a PCCH channel according to the PCCH configuration information received by the configuration information receiving unit 501 to monitor network paging, and determine, according to the BCCH configuration information received by the configuration information receiving unit 501, a moment for updating a system message after reception of the paging.

A UE according to an embodiment of the present invention will be described in detail hereinafter. Referring to FIG. 6, the UE according to another embodiment of the present invention includes: a configuration information receiving unit 601 configured to receive a handover configuration message sent by a source base station, where the handover configuration message includes PCCH configuration information and BCCH configuration information of a target cell; and a channel monitoring processing unit 602 configured to establish a PCCH channel according to the PCCH configuration information received by the configuration information receiving unit 601 to monitor network paging, and determine, according to the BCCH configuration information received by the configuration information receiving unit 601, a moment for updating a system message after reception of the paging.

The UE in this embodiment may further include: a completion message sending unit 603 configured to send a handover configuration completion message to a target base station.

The UE in this embodiment may further include: a channel establishing unit 604 configured to establish a BCCH channel when the moment determined by the channel monitoring processing unit 602 for updating the system message is reached; a system message receiving unit 605 configured to receive, via the BCCH channel established by the channel establishing unit 604, a system message broadcast by the target base station; and a channel releasing unit 606 configured to release the BCCH channel after the system message receiving unit 605 finishes receiving the system message.

In order to facilitate understanding, interaction among units of the UE according to the embodiment of the present invention will be described in detail hereinafter in combination with a specific application scenario.

In this embodiment, when the UE determines to initiate cell handover, or a network side determines to require the UE to initiate cell handover, the UE may send a measurement report to the source base station, and the configuration information receiving unit 601 of the UE may receive the handover configuration message from the source base station.

The handover configuration cell includes the PCCH configuration information and the BCCH configuration information of the target cell.

It should be noted that, the reason for the UE to initiate cell handover may be location update, routing area update, or signal quality reduction, and the details are not limited herein.

After receiving the handover configuration message from the source base station, the configuration information receiving unit 601 may read the PCCH configuration information and the BCCH configuration information of the target cell from the message. Therefore, the channel monitoring processing unit 602 may establish the PCCH channel according to the PCCH configuration information to monitor the network paging, and determine, according to the BCCH configuration information, the moment for updating the system message after reception of the paging.

The PCCH configuration information in this embodiment is used to establish the PCCH channel, and the PCCH channel is used to monitor the network paging. The BCCH configuration information in this embodiment is used to determine the moment for updating the system message after the network paging is monitored.

Up to this point, the UE may monitor the network paging in the target cell, which may be regarded as completion of the cell handover.

In addition, after the configuration information receiving unit 601 receives the handover configuration message from the source base station, the completion message sending unit 603 may send the handover configuration completion message to the target base station, or the completion message sending unit 603 may also send the handover configuration completion message to the target base station after the channel monitoring processing unit 602 executes the corresponding process, and the details are not limited herein.

It should be noted that, when the channel monitoring processing unit 602 learns, by monitoring the network paging, that the system message needs to be updated (that is, the moment determined by the channel monitoring processing unit 602 for updating the system message is reached), the channel establishing unit 604 may establish the BCCH channel in the target cell. The system message receiving unit 605 receives, via the established BCCH channel, the system message broadcast by the target base station. After the system message receiving unit 605 finishes receiving the system message, the channel releasing unit 606 releases the BCCH channel.

In this embodiment, the handover configuration message received by the configuration information receiving unit 601 from the source base station includes the PCCH configuration information and the BCCH configuration information of the target cell, and the channel monitoring processing unit 602 may directly establish the PCCH channel according to the PCCH configuration information to monitor the network paging, and determine, according to the BCCH configuration information, the moment for updating the system message after reception of the paging. Since the handover configuration message is sent before an SIB2 broadcast by the target base station, the UE may receive the PCCH configuration information and the BCCH configuration information in a more timely manner, so as to shorten channel establishment time during LTE cell handover, thereby improving real-time monitoring effect after the UE is handed over to the target cell.

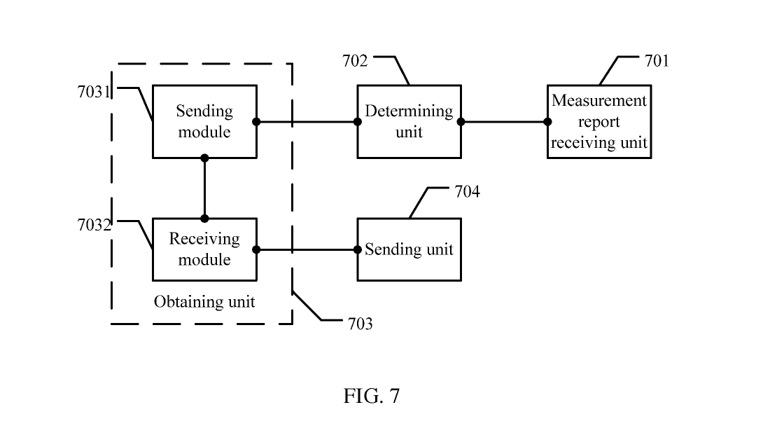

A base station according to an embodiment of the present invention will be described in detail hereinafter. Referring to FIG. 7, a base station according to an embodiment of the present invention includes: a measurement report receiving unit 701 configured to receive a measurement report sent by a UE; a determining unit 702 configured to determine a target base station corresponding to the measurement report received by the measurement report receiving unit 701; an obtaining unit 703 configured to obtain PCCH configuration information and BCCH configuration information of a target cell from the target base station determined by the determining unit 702; and a sending unit 704 configured to send a handover configuration message to the UE, where the handover configuration message includes the PCCH configuration information and the BCCH configuration information that are obtained by the obtaining unit.

The obtaining unit 703 in this embodiment may further include: a sending module 7031 configured to send a handover request to the target base station; and a receiving module 7032 configured to receive a handover response sent by the target base station, where the handover response includes the PCCH configuration information and the BCCH configuration information of the target cell.

The base station in this embodiment may be the source base station described in the above method embodiments. In order to facilitate understanding, interaction among units of the base station according to the embodiment of the present invention will be described in detail hereinafter in combination with a specific application scenario.

In this embodiment, when the UE determines to initiate cell handover, or a network side determines to require the UE to initiate cell handover, the UE may send the measurement report to the measurement report receiving unit 701 of the source base station.

The handover configuration cell includes the PCCH configuration information and the BCCH configuration information of the target cell.

It should be noted that, the reason for the UE to initiate cell handover may be location update, routing area update, or signal quality reduction, and the details are not limited herein.

After the measurement report receiving unit 701 receives the measurement report sent by the UE, the determining unit 702 may determine the target base station corresponding to the measurement report.

It should be noted that, the measurement report sent by the UE may carry information of several candidate target base stations for selection, or the determining unit 702 may also select the target base station according to other information, and the specific process is commonly known to persons skilled in the art, and is not limited herein.

After the determining unit 702 determines the target base station, the obtaining unit 703 may obtain the PCCH configuration information and the BCCH configuration information of the target cell from the target base station, and the specific obtaining process may be as follows: the sending module 7031 sends the handover request to the target base station; and the receiving module 7032 receives the handover response sent by the target base station, where the handover response includes the PCCH configuration information and the BCCH configuration information of the target cell.

Or, the obtaining unit 703 may also obtain the PCCH configuration information and the BCCH configuration information of the target cell from the target base station through another process of interaction with the target base station, which is not limited herein.

In this embodiment, after the obtaining unit 703 obtains the PCCH configuration information and the BCCH configuration information of the target cell from the target base station, the sending unit 704 may send the handover configuration message to the UE, where the handover configuration message includes the PCCH configuration information and the BCCH configuration information of the target cell.

In this embodiment, the sending unit 704 may send the handover configuration message including the PCCH configuration information and the BCCH configuration information of the target cell to the UE, so that after receiving the message, the UE may directly establish a PCCH channel according to the PCCH configuration information to monitor the network paging, and determine, according to the BCCH configuration information, a moment for updating a system message after reception of the paging. Since the handover configuration message is sent before an SIB2 broadcast by the target base station, the UE may receive the PCCH configuration information and the BCCH configuration information in a more timely manner, so as to shorten channel establishment time during LTE cell handover, thereby improving real-time monitoring effect after the UE is handed over to the target cell.

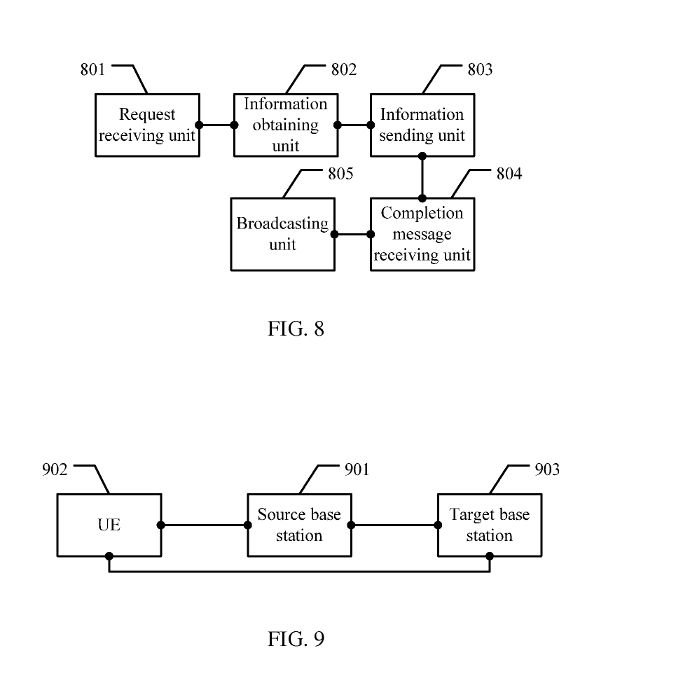

A base station according to an embodiment of the present invention will be described hereinafter in detail. Referring to FIG. 8, a base station according to another embodiment of the present invention includes: a request receiving unit 801 configured to receive a handover request sent by a source base station; an information obtaining unit 802 configured to obtain PCCH configuration information and BCCH configuration information of a target cell; and an information sending unit 803 configured to send a handover response to the source base station, where the handover response includes the PCCH configuration information and the BCCH configuration information of the target cell that are obtained by the information obtaining unit 802.

The base station in this embodiment may further include: a completion message receiving unit 804 configured to receive a handover configuration completion message sent by a UE; and a broadcasting unit 805 configured to broadcast a system message on a BCCH channel.

The base station in this embodiment may be the target base station described in the above method embodiments. In order to facilitate understanding, interaction among units of the base station according to the embodiment of the present invention will be described in detail hereinafter in combination with a specific application scenario.

In this embodiment, when a UE determines to initiate cell handover, or a network side determines to require the UE to initiate cell handover, the UE may send a measurement report to the source base station.

The source base station may determine a target base station according to the measurement report, and send the handover request to the request receiving unit 801 of the target base station. Therefore, the request receiving unit 801 may receive the handover request sent by the source base station.

After the request receiving unit 801 receives the handover request sent by the source base station, the information obtaining unit 802 may obtain the PCCH configuration information and the BCCH configuration information of the target cell.

It should be noted that, the information obtaining unit 802 may obtain the PCCH configuration information and the BCCH configuration information of the cell that the target base station serves (that is, the target cell) from the target base station, and may also obtain the PCCH configuration information and the BCCH configuration information of the target cell from another network element (for example, a network element of a core network), and the details are not limited herein.

In this embodiment, the information sending unit 803 may carry the PCCH configuration information and the BCCH configuration information of the target cell that are obtained by the information obtaining unit 802 in the handover response and send the handover response to the source base station.

In this embodiment, the information sending unit 803 may carry the obtained PCCH configuration information and BCCH configuration information of the target cell in the handover response and send the handover response to the source base station, so that the source base station may send a handover configuration message including the PCCH configuration information and the BCCH configuration information of the target cell to the UE, and further, after receiving the message, the UE may directly establish a PCCH channel according to the PCCH configuration information to monitor the network paging, and determine, according to the BCCH configuration information, a moment for updating a system message after reception of the paging. Since the handover configuration message is sent before an SIB2 broadcast by the target base station, the UE may receive the PCCH configuration information and the BCCH configuration information in a more timely manner, so as to shorten channel establishment time during LTE cell handover, thereby improving real-time monitoring effect after the UE is handed over to the target cell.

An embodiment of the present invention further provides a communications system. Referring to FIG. 9, a communications system according to an embodiment of the present invention includes: a source base station 901 configured to receive a measurement report sent by a user equipment 902, determine a target base station corresponding to the measurement report, obtain PCCH configuration information and BCCH configuration information of a target cell from the target base station 903, and send a handover configuration message to the UE 902, where the handover configuration message includes the PCCH configuration information and the BCCH configuration information; the UE 902 configured to send the measurement report to the source base station 901, receive the handover configuration message sent by the source base station 901, where the handover configuration message includes the PCCH configuration information and the BCCH configuration information of the target cell, establish a PCCH channel according to the PCCH configuration information to monitor network paging, determine, according to the BCCH configuration information, a moment for updating a system message after reception of the paging, and send a handover configuration completion message to the target base station 903; and the target base station 903 configured to receive the handover configuration completion message sent by the UE 902, and broadcast the system message on a BCCH channel.

The specific structure and function of the source base station 901 in this embodiment may be the same with the structure and function described in the embodiment shown in FIG. 7, and the details are not described herein again.

The specific structure and function of the UE 902 in this embodiment may be the same with the structure and function described in the embodiment shown in FIG. 5 or FIG. 6, and the details are not described herein again.

The specific structure and function of the target base station 903 in this embodiment may be the same with the structure and function described in the embodiment shown in FIG. 8, and the details are not described herein again.

In the embodiments of the present invention, the handover configuration message received by the UE 902 from the source base station 901 includes the PCCH configuration information and the BCCH configuration information of the target cell. The UE 902 may directly establish the PCCH channel according to the PCCH configuration information to monitor the network paging, and determine, according to the BCCH configuration information, the moment for updating the system message after reception of the paging. Since the handover configuration message is sent before the SIB2 broadcast by the target base station 903, the UE 902 may receive the PCCH configuration information and the BCCH configuration information in a more timely manner, so as to shorten channel establishment time during LTE cell handover, thereby improving real-time monitoring effect after the user equipment 902 is handed over to the target cell.

It may be clearly understood by persons skilled in the art that, for the purpose of convenient and brief description, for a detailed working process of the foregoing system, apparatus and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and the parts displayed as units may or may not be physical units, may be located in one position, or may be distributed on a plurality of network units. A part of or all of the units may be selected according to actual needs to achieve the objectives of the solutions of the embodiments.

In addition, functional units in the embodiments of the present invention may be integrated into one processing unit, or each of the units may exist alone physically, or two or more units may be integrated into one unit. The integrated units may be implemented in a form of hardware, or may be implemented in a form of a software functional unit.

When the integrated units are implemented in a form of a software functional unit and sold or used as an independent product, the integrated units may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium and includes several instructions for instructing a computer device (which may be a personal computer, a server, or a network device or the like) to perform all or a part of the steps of the methods described in the embodiments of the present invention. The foregoing storage medium includes any mediums capable of storing program code, such as a universal serial bus (USB) flash disk, a removable hard disk, a read-only memory (ROM), a random access memory (RAM), a magnetic disk, or an optical disc.

The foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features thereof, as long as such modifications or replacements do not cause the essence of corresponding technical solutions to depart from the spirit and scope of the technical solutions of the embodiments of the present invention.

What is claimed is:

1. A cell handover control method, comprising:
receiving, by a user equipment (UE), a handover configuration message sent by a source base station, wherein the handover configuration message comprises paging control channel (PCCH) configuration information and broadcast control channel (BCCH) configuration information of a target cell; and
establishing, by the UE, a PCCH channel according to the PCCH configuration information to monitor network paging, and determining, according to the BCCH configuration information, a moment for updating a system message after reception of the paging.

2. The method according to claim 1, wherein before or after establishing, by the UE, the PCCH channel according to the PCCH configuration information to monitor network paging, and determining, according to the BCCH configuration information, the moment for updating the system message after reception of the paging, the method further comprises sending, by the UE, a handover configuration completion message to a target base station.

3. The method according to claim 1, further comprising:
establishing, by the UE, a BCCH channel when the moment for updating the system message is reached;
receiving, by the UE via the BCCH channel, a system message broadcast by the target base station; and
releasing, by the UE, the BCCH channel.

4. A cell handover control method, comprising:
receiving, by a source base station, a measurement report sent by a user equipment (UE);
determining, by the source base station, a target base station corresponding to the measurement report;
obtaining, by the source base station, paging control channel (PCCH) configuration information and broadcast control channel (BCCH) configuration information of a target cell from the target base station; and
sending, by the source base station, a handover configuration message to the UE, wherein the handover configuration message comprises the PCCH configuration information and the BCCH configuration information.

5. The method according to claim 4, wherein obtaining, by the source base station, the PCCH configuration information and the BCCH configuration information of the target cell from the target base station comprises:
sending, by the source base station, a handover request to the target base station; and
receiving, by the source base station, a handover response sent by the target base station, wherein the handover response comprises the PCCH configuration information and the BCCH configuration information of the target cell.

6. A cell handover control method, comprising:
receiving, by a target base station, a handover request sent by a source base station;
obtaining, by the target base station, paging control channel (PCCH) configuration information and broadcast control channel (BCCH) configuration information of a target cell; and
sending, by the target base station, a handover response to the source base station, wherein the handover response comprises the PCCH configuration information and the BCCH configuration information of the target cell.

7. The method according to claim 6, wherein after sending, by the target base station, the handover response to the source base station, the method further comprises:
receiving, by the target base station, a handover configuration completion message sent by a user equipment (UE); and
broadcasting, by the target base station, a system message on a BCCH channel.

8. A user equipment, comprising:
a configuration information receiving unit configured to receive a handover configuration message sent by a source base station, wherein the handover configuration message comprises paging control channel (PCCH) configuration information and broadcast control channel (BCCH) configuration information of a target cell; and
a channel monitoring processing unit configured to establish a PCCH channel according to the PCCH configuration information received by the configuration information receiving unit to monitor network paging, and determine, according to the BCCH configuration information received by the configuration information receiving unit, a moment for updating a system message after reception of the paging.

9. The user equipment according to claim 8, further comprising a completion message sending unit configured to send a handover configuration completion message to a target base station.

10. The user equipment according to claim 8, wherein the user equipment further comprises:
a channel establishing unit configured to establish a BCCH channel when the moment determined by the channel monitoring processing unit for updating the system message is reached;
a system message receiving unit configured to receive, via the BCCH channel established by the channel establishing unit, a system message broadcast by the target base station; and
a channel releasing unit configured to release the BCCH channel after the system message receiving unit finishes receiving the system message.

11. A base station, comprising:
a measurement report receiving unit configured to receive a measurement report sent by a user equipment (UE);
a determining unit configured to determine a target base station corresponding to the measurement report received by the measurement report receiving unit;
an obtaining unit configured to obtain paging control channel (PCCH) configuration information and broadcast control channel (BCCH) configuration information of a target cell from the target base station determined by the determining unit; and
a sending unit configured to send a handover configuration message to the UE, wherein the handover configuration message comprises the PCCH configuration information and the BCCH configuration information that are obtained by the obtaining unit.

12. The base station according to claim 11, wherein the obtaining unit comprises:
a sending module configured to send a handover request to the target base station; and
a receiving module configured to receive a handover response sent by the target base station, wherein the handover response comprises the PCCH configuration information and the BCCH configuration information of the target cell.

13. A base station, comprising:
a request receiving unit configured to receive a handover request sent by a source base station;
an information obtaining unit configured to obtain paging control channel (PCCH) configuration information and broadcast control channel (BCCH) configuration information of a target cell; and
an information sending unit configured to send a handover response to the source base station, wherein the handover response comprises the PCCH configuration information and the BCCH configuration information of the target cell that are obtained by the information obtaining unit.

14. The base station according to claim 13, further comprising:
a completion message receiving unit configured to receive a handover configuration completion message sent by a user equipment (UE); and
a broadcasting unit configured to broadcast a system message on a BCCH channel.

15. A communications system, comprising:
a source base station configured to receive a measurement report sent by a user equipment, determine a target base station corresponding to the measurement report, obtain paging control channel (PCCH) configuration information and broadcast control channel (BCCH) configuration information of a target cell from the target base station, and send a handover configuration message to the user equipment, wherein the handover configuration message comprises the PCCH configuration information and the BCCH configuration information;
the user equipment configured to send the measurement report to the source base station, receive the handover configuration message sent by the source base station, wherein the handover configuration message comprises the PCCH configuration information and the BCCH configuration information of the target cell, establish a PCCH channel according to the PCCH configuration information to monitor network paging, determine, according to the BCCH configuration information, a moment for updating a system message after reception of the paging, and send a handover configuration completion message to the target base station; and
the target base station configured to receive the handover configuration completion message sent by the user equipment, and broadcast the system message on a BCCH channel.
